(19) United States
(12) Patent Application Publication
(10) Pub. No.: US 2007/0152828 A1
(43) Pub. Date: Jul. 5, 2007

(54) Methods and apparatus for tag activation

(76) Inventor: Swarup Kumar Mohalik, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,921

(22) Filed: Jul. 26, 2006

(30) Foreign Application Priority Data
Aug. 31, 2005 (IN) IN1219/CHE/2005

(51) Int. Cl. G08B 13/14; H04Q 5/22

(52) U.S. Cl. 340/572.3; 340/10.4

(57) ABSTRACT

An identification tag comprising a memory configured to store an identification code, a radio communication portion configured to transmit the identification code stored in the memory when receiving a predetermined signal and a switch configured to be user-operable to enable the radio communication portion. The tag may correspond to a RFID tag where the switch is pressure actuated or similar.

### BACKGROUND TO THE INVENTION

Various types of electromagnetic (EM) read/write tag devices are known. These devices are available in a wide variety of form factors, and incorporate circuitry which is configured to store data along with means to receive and transmit data by means of electromagnetic signals. One of the more popular types of electromagnetic read/write tag devices are Radio Frequency Identification (hereafter referred to as RFID) tags. RFID tags are well known in tracking, inventory and related technologies and can be passive (unpowered) or active (powered). Passive RFID devices draw their power from an electromagnetic field supplied by a proximate reading/writing device. Inductive and similar forms of non-contact power-supply are well known in the electronic arts and for brevity will not be discussed in detail. Active RFID devices generally incorporate an internal source of power such as a battery. This description contemplates both types of EM read/write device.

When a RFID reading device is located near an RFID tag and operated in read mode, the electromagnetic field emitted by the reader energises an antenna associated with the tag. This powers the tag circuitry and, in the case of a passive RFID tag, provides the necessary power to transmit the data held in the tag's memory. A powered tag may emit signals constantly, in which case a passive reader can be used to read the transmitted data. Using an appropriately configured RFID device, data can also be written into the tag's memory in a similar manner.

RFID tags provide many advantages such as low cost and completely automatic or passive operation. For example, when RFID tags are used for stock inventory in retail environments, customers are often unaware that the items they are purchasing have an embedded RFID tag and that tracking data has been read from them as the items are processed at the time of purchase. Similarly, a significant advantage of embedded RFID tags are that they can be hidden in objects and thus enable metadata to be associated with virtually any type of object. Various types of tag form-factor are available. One of the more common is a planar structure referred to as a label RFID tag. These are sometimes manufactured with an adhesive on one side and can be easily attached to articles. The antenna of such tags is generally of a stripline form and is sometimes fabricated as a planar series of concentric antenna filaments.

The well known automatic or passive readability and operation of RFID tags provides significant advantages and this has, to a large degree, defined the type of applications to which these devices have been put. However, the lack of user control has prevented the use of RFID tags in situations where selective exposure of tag data is required.

### BRIEF DESCRIPTION OF THE DRAWINGS

Embodiments of the invention will now be described by way of example only and with reference to the drawings in which:

FIG. 1 illustrates a schematic of a tag according to an embodiment of the invention;

FIG. 2 illustrates a printed sheet incorporating tags according to an embodiment of the invention;

FIG. 3 illustrates a keyboard incorporating tags according to an embodiment of the invention; and

FIG. 4 illustrates an RFID reader that can be selectively activated by means of interrogating a tag according to an embodiment of the invention.

### DISCLOSURE OF THE INVENTION

In one aspect, the technique disclosed, provides a tag comprising:
a memory configured to store an identification code;
a radio communication portion configured to transmit the identification code stored in the memory when receiving a predetermined signal; and
a switch configured to be user-operable to enable the radio communication portion.

The switch is preferably directly or indirectly user-operable to cause a variation in the electrical characteristics of said switch so as to enable the radio communication portion when operated by a user.

The switch preferably operates to enable the radio communication portion when contact or pressure is applied to said switch.

The switch is preferably a pressure switch, capacitative switch, resistive switch, hall effect switch, magnetoresistive switch, reed switch, inductive proximity switch or similar.

In a preferred embodiment, the switch is a pressure switch, preferably in the form of a membrane switch.

In an alternative embodiment, the switch may be operated by the output of a sensor, wherein the sensor operates so as to close the switch on the basis of the sensor passing a predetermined sensor threshold measurement.

The sensor may be a moisture, chemical, temperature or other type of environmental sensor.

The tag may have a planar form-factor and the switch be a membrane switch.

The switch may additionally be configured to provide tactile feedback to a user on actuation.

The tag is preferably an RFID tag.

The technique further provides a sheet of planar tags, each having a corresponding switch.

The disclosure further provides a keyboard wherein the keys correspond to tags has hereinbefore defined.

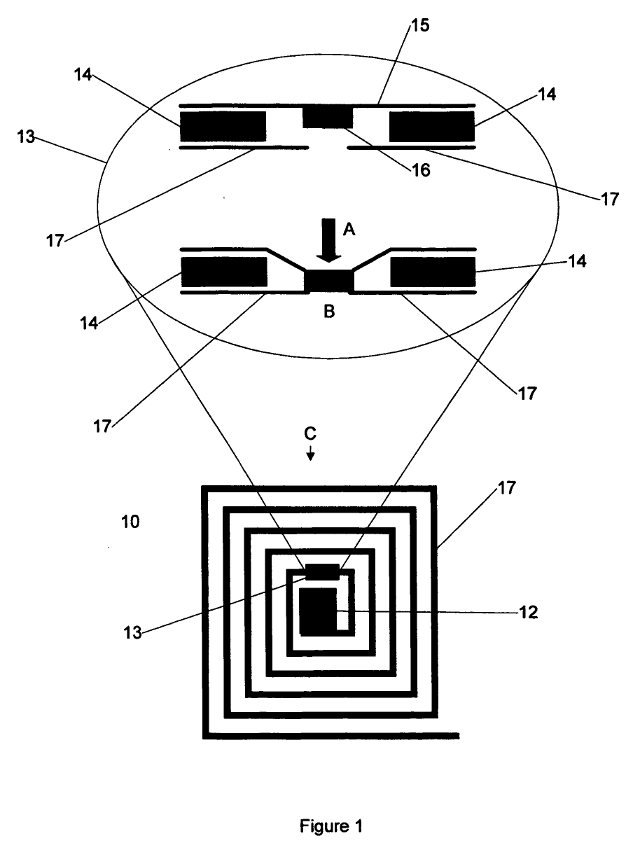

FIG. 1 illustrates a simplified schematic of an embodiment of the present disclosure. Referring to FIG. 1, a tag or identification tag 10 is shown, and includes a memory 12 configured to store an identification code, a radio communication portion 17 configured to transmit the identification code stored in the memory 12 when receiving a predetermined signal from an external reader (not shown), and a switch 13. The switch 13 is user-operable so as to enable the radio communication portion 17. When the switch 13 is open, the RFID tag is ‘dead’, that is, unable to be scanned or read by a reader.

The embodiment shown in FIG. 1 shows a RFID tag which has a radio portion in the form of an antenna and a central part including memory 12. The central part may also contain circuitry required to control the operation of the tag and may be in the form of a purpose built integrated circuit which may incorporate the memory. A number of circuit configurations are possible as will be clear to the person skilled in the art. Identification information may include user-specific data, data strings, urls or any other form of digitally encoded information which is capable of being written into the memory 12.

Considering the lower part of FIG. 1, in the default configuration, the switch 13 is open and the RFID tag is “dead”. That is, the radio portion 17 is not “enabled”. This can be seen in the RFID embodiment of the disclosure in FIG. 1 where even if a RFID reader was held near the tag 10 and switched on, the induced current in the radio portion or antenna 17, would not be applied to the memory 12 at the center of the tag 10 due to the break in the circuit at the switch 13. The switch 13 is shown as being located proximate the output of the memory/circuitry part 12. However, the switch 13 could be physically located elsewhere in relation to the tag with appropriate conducting track layout. For example, the switch 13 could be located at the outer perimeter of the tag 10 and suitably insulating conductive tracks positioned across the antenna array 17.

A simplified side-view cross-section view of the switch looking in the direction C 1 is shown in the upper enlarged part of FIG. 1. Here, the upper arrangement represents the default or inactive configuration of the switch. Referring to the embodiment shown in the upper cross-section, the switch is in the form of a membrane switch having an upper switch pad 15 on the underside of which is located a conductive switch bar 16. The underside of the switch includes a conductive track 17 with a break at the point indicated by the letter B. Insulating layer 14 is interposed between the upper and lower components 15 and 17 and incorporates an aperture through which the switch bar 16 protrudes. For clarity, all other components of the membrane switch have been omitted.

When pressure is applied in the direction A, the switch bar 16 is depressed and brought into contact with the ends of the conductive antenna track 17. This closes the circuit and enables the antenna (the radio portion).

Thus, if the RFID tag is squeezed while it is in the proximity of a powered reader, the radio portion or antenna 17 will be enabled, and the induced current will cause the circuitry embedded in the central portion, and elsewhere depending on the specific design adopted, to function. This will typically cause the identification code stored in the memory 12 to be transmitted by the radio portion 17 thus allowing the RFID tag to be read.

The switch 13 can be directly or indirectly activated. For example, in the case of a planar, label form-factor tag, a user can simply press the area of the tag 10. In other embodiments, the switch may be operated by a separate mechanical device such as a key similar to that found on a keyboard. Other switch types are possible including capacitative, resistive, hall effect, magnetoresistive, reed, inductive proximity and the like. Pressure activated membrane switches are considered useful in many applications as they are relatively inexpensive, robust and can be fabricated in thin planar shapes and can therefore be integrated with standard RFID tag form-factors.

In another aspect of this disclosure, the switching action may be initiated by means of an output signal emitted from one of a variety of sensors. For example, a temperature sensor may close the switch when a predetermined temperature threshold is passed. Other sensors are envisaged including pressure threshold sensors, chemical sensors, moistures sensors and the like. Such variants would provide means to remotely monitor various environmental parameters in a passive manner.

In alternative embodiments, the switch may be configured to provide tactile feedback. This can be done with appropriate modification of the membrane switch structure to provide a relatively stiff upper membrane and a resilient arrangement to provide a snap action on applying pressure to the switch.

The tag according to the disclosure may be used in a number of novel applications hitherto considered untenable given the accepted construction of RFID tags. One application is in the manufacture of active RFID tags. Active RFID tags have an inbuilt power source, usually in the form of a battery. Using the technique described in this disclosure in this situation would significantly extend the life of the tag as the battery would only be used when the tag is activated by a user.

Another example is where a user wishes to only expose data stored in an RFID tag temporarily for privacy or other reasons. In this context, the ability to selectively enable the tag for reading is very important. One application for such technology is in the field of human embedded RFID technology. In this situation, one or more RFID tags are embedded under the skin of a human recipient. According to known approaches, the recipient of such a tag would be unable to control whether or not the stored identification information is exposed or not. He or she would simply need to pass in the reading range of a RFID scanner and their identification data would be exposed and readable. There are some solutions where a writer writes a special (privacy) bit in the tag. However, this approach needs special writers to toggle the required bit. The availability of the proper writer device restricts the toggling of the bit by the choice of a user. However, using tags manufactured according to the technique disclosed incorporating a suitably tuned pressure-sensitive switch, it would be possible to embed a tag which is only capable of being read when, for example, the recipient applies gentle pressure to the skin immediately above the embedded tag.

In another application, planar or label form-factor RFID tags manufactured according to an embodiment of the disclosure may be printed onto a sheet of paper and thus areas of the sheet may be treated as ‘active’ once the tags have information written into them. An example of such an application might be an RFID-enabled menu whereby a diner could press the menu on or near the textual description of the menu item. This could transmit the users selection to a reading device. Alternative and expanded embodiments could include options for amending their choices depending on where on the menu the sheet is pressed.

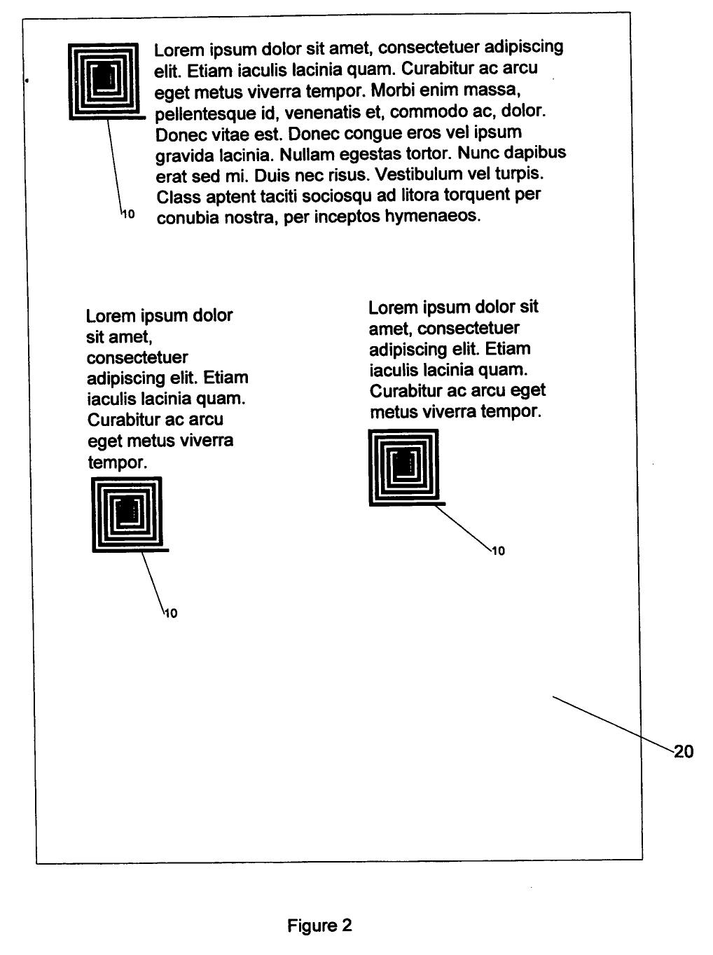

Such an embodiment is illustrated in schematic form in FIG. 2. Here, a sheet 20 has areas of text associated with planar or label form-factor RFID tags 10. The RFID tags have been illustrated in enlarged form and it is envisaged that the tags 10 may be significantly smaller as well as be embedded into the paper and thus virtually concealed from the user. In this arrangement some indicia or textual matter would indicate where the user should press the sheet to obtain the requisite data reading action. The indicia could be printed over the tag areas.

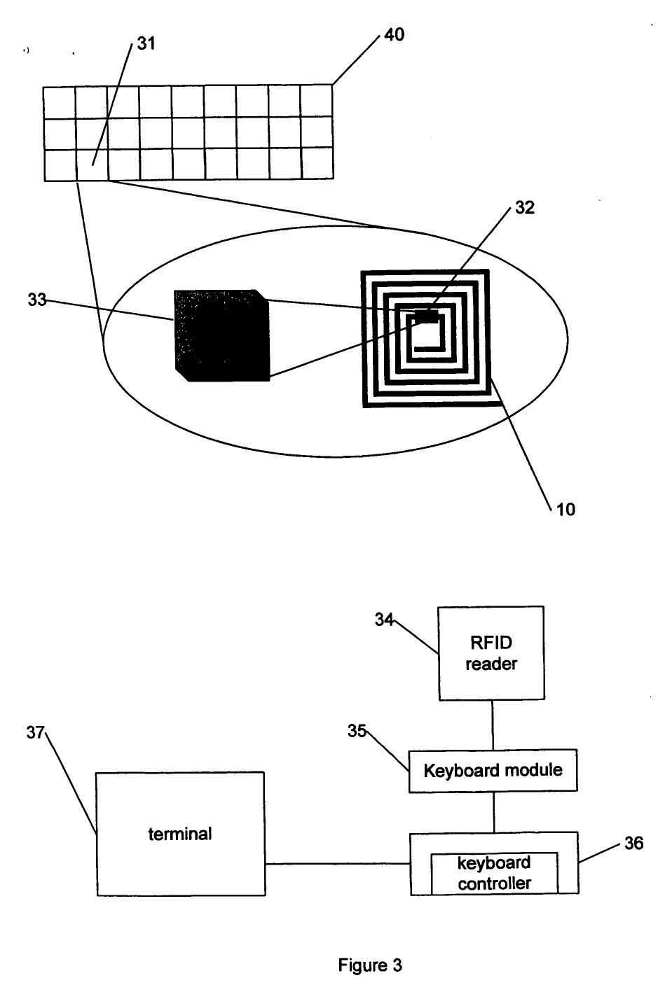

Another potential application may be in the manufacture of very low-profile keyboard. An example 40 is shown schematically in FIG. 3. Here, each key 33, in this case, the “G” key, would have a unique code embedded in a tag 10 associated with the key. The keyboard or associated computer 37 would have a reader 34 such that when any key is pressed, the RFID data is emitted and detected by the reader 34 thus allowing the key identification to be decoded by a keyboard module 35 and the appropriate key data sent to the computers keyboard controller 36. Such a keyboard could be completely wireless and unpowered and may therefore find particular application in environments where keypads or keyboards are required to be simple, wireless and possibly isolated from their outside environment physically and electrically.

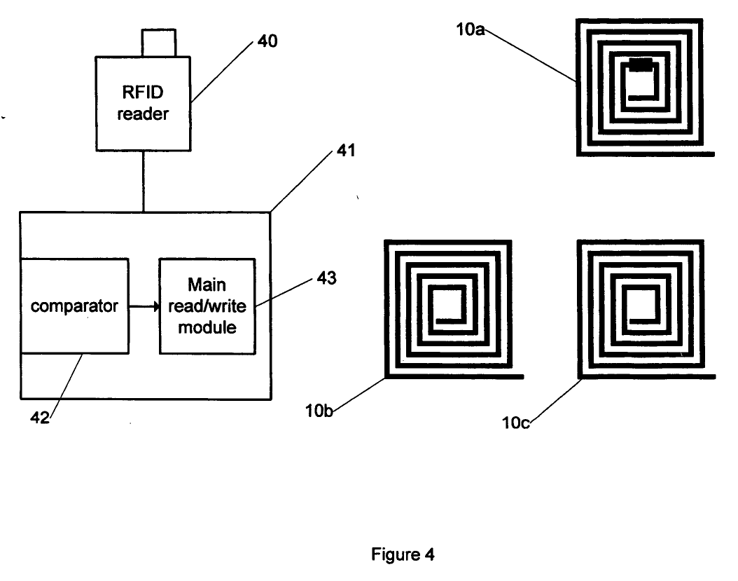

A further application of tags made according to an embodiment of the disclosure is illustrated in FIG. 4. Here, tag 10a is a tag which includes a pressure switch. When it is activated by closing the switch, it emits tag data which is read by the RFID reader 40. A comparator 42 in the reader compares the tag data with a stored data value. When and only when this data matches, the main reader is allowed to scan for any other tags in its proximity. Thus, when tag 10a is pressed, tags 10b and 10c are able to be read by the reader.

Other applications will become apparent to one skilled in the art, all of which exploit the non-intuitive application of ‘dead’ RFID tags.

Although the technique has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A tag comprising:
a memory configured to store an identification code;
a radio communication portion configured to transmit the identification code stored in the memory when receiving a predetermined signal; and
a switch configured to be user-operable to enable the radio communication portion.

2. A tag as claimed in claim 1 wherein the switch is directly or indirectly user-operable to cause a variation in electrical characteristics of said switch so as to enable the radio communication portion when operated by a user.

3. A tag as claimed in claim 1 wherein the switch operates to enable the radio communication portion when contact or pressure is applied to said switch.

4. A tag as claimed in claim 1 wherein the switch is a pressure switch, capacitative switch, resistive switch, hall effect switch, magnetoresistive switch, reed switch, inductive proximity switch or similar.

5. A tag as claimed in claim 1 wherein the switch is operated by the output of a sensor.

6. A tag as claimed in claim 5 wherein the sensor operates so as to close the switch on the basis of it passing a predetermined threshold measurement.

7. A tag as claimed in claim 1 wherein the switch is a pressure switch in the form of a membrane switch.

8. A tag as claimed in claim 1 wherein the tag has a planar form-factor and the switch is a membrane switch.

9. A tag as claimed in claim 1 wherein the switch is configured to provide tactile feedback to a user on actuation.

10. A tag as claimed in claim 1 wherein the tag is an RFID tag.

11. A sheet incorporating a plurality of tags as claimed in claim 1.

12. A keyboard incorporating a plurality of tags as claimed in claim 1, configured so that at least one key is associated with a corresponding tag wherein when the key is pressed, the tag is enabled.

13. A keyboard as claimed in claim 12 in the form of a plurality of membrane switches, each comprising a tag as claimed in any one of claims 1 to 10.

14. A tag reader adapted to have one or more of its internal functions activated on receipt of a predetermined signal emitted by a tag as claimed in claim 1.
